(19) United States
(12) Patent Application Publication
(10) Pub. No.: US 2014/0260337 A1
(43) Pub. Date: Sep. 18, 2014

(54) Method of Producing Natural Gas from Remote and/or Isolated Offshore Reservoirs

(71) Applicant: TULLOW GROUP SERVICES LIMITED, (US)

(72) Inventor: Shahrokh Mohammadi, London (GB)

(21) Appl. No.: 13/803,341

(22) Filed: Mar. 14, 2013

(51) Int. Cl. F17C 5/02

(52) U.S. Cl. CPC F17C 5/02
USPC 62/47.1

(57) ABSTRACT

A method of producing natural gas from at least one reservoir, the method including the steps of producing the natural gas from the at least one reservoir; liquefying a first tranche of the natural gas to produce liquefied natural gas; and compressing a second tranche of the natural gas to produce a compressed natural gas.

### BACKGROUND

The present invention relates to a method of producing natural gas from remote and/or isolated offshore reservoirs.

Rising oil and gas prices mean that reservoirs that were previously uneconomical to work are now becoming economical. However other reservoirs are located offshore and are in deepwater and so remain uneconomical. This makes the removal of the oil and gas difficult and expensive. New equipment and methods must be developed for the economic exploitation of these reservoirs.

### SUMMARY

In accordance with a first aspect of the present invention there is provided a method of producing natural gas from at least one reservoir, the method including the steps of:
producing the natural gas from the at least one reservoir;
liquefying a first tranche of the natural gas to produce liquefied natural gas; and
compressing a second tranche of the natural gas to produce a compressed natural gas.

The step of liquefying the first tranche of the natural gas to produce liquefied natural gas is typically done using a dedicated marine floating vessel. The step of compressing the second tranche of the natural gas to produce a compressed natural gas is typically done using a dedicated marine floating vessel.

The step of compressing the second tranche of the natural gas may include using cargo carriers.

The step of compressing the second tranche of the natural gas to produce the compressed natural gas is typically after the step of liquefying the first tranche of the natural gas to produce the liquefied natural gas.

The step of liquefying the first tranche of the natural gas to produce the liquefied natural gas may last from 3 to 8 years, normally from 3 to 7 years, typically from 3 to 5 years.

The first and second tranches may also be referred to as first and second portions respectively.

The method may further include one or more of the steps of, identifying a suitable reservoir to exploit; drilling a well bore; installing a well casing through which the natural gas can be produced; and providing fluid communication between the well bore and surface through a free standing riser. The free standing riser may have fixed buoyancy attached to it at or near sea level. The fixed buoyancy may assist in determining the profile and/or positioning of the free standing riser.

A riser may terminate below the surface of the water at a suitable depth and may be connected to a floater. Fluid communication between the floater and a vessel on the surface of the water is typically provided by a flexible jumper.

The method typically includes the step of connecting the flexible jumper to a vessel adapted to liquefy the first tranche of the natural gas. The method typically also includes the step of disconnecting the flexible jumper from the vessel adapted to liquefy the first tranche of the natural gas and connecting it to a vessel adapted to compress the second tranche of the natural gas.

The step of disconnecting the flexible jumper from the vessel adapted to liquefy the first tranche of the natural gas and connecting it to the vessel adapted to compress the second tranche of the natural gas may take from 3 to 28 days, typically from 5 to 12 days.

After disconnecting the flexible jumper from the vessel adapted to liquefy the first tranche of the natural gas, the method may further include the step of disconnecting the flexible jumper from the floater and changing the flexible jumper for one that is suitable for connection to the vessel adapted to compress the second tranche of the natural gas. The change of vessel is typically due to a change in reservoir pressure after the first tranche of production.

When there is more than one reservoir and once the flexible jumper has been disconnected from the vessel adapted to liquefy the first tranche of the natural gas, the same vessel may be moved to a second reservoir and used in the production of natural gas from this second reservoir. The vessel adapted to liquefy the first tranche of the natural gas from the at least one reservoir may therefore be used at more than one reservoir or more than one well in fluid communication with the same reservoir. The reservoir may be a gas reservoir.

When there is more than one reservoir, the reservoirs may be any distance apart but may typically be from 5 to 100 miles apart, normally from 15 to 60 miles apart. The vessel adapted to liquefy the first tranche of the natural gas may be operated at from 2 to 10, normally from 2 to 5 and typically 3 different reservoirs. The vessel adapted to liquefy the first tranche of the natural gas may be referred to as a Mobile or Moving Liquefied Natural Gas vessel or MLNG vessel.

The MLNG vessel may be located at a particular reservoir for from 5 to 15 years, normally from 5 to 10 years and usually about 7 years.

When there is more than one reservoir the reservoirs may be ‘non-associated’, that is isolated natural gas reservoirs, or may be ‘associated’, that is natural gas present in predominantly oil reservoirs.

The reservoir may be offshore. The reservoir may be under the seabed. The depth of the water above the seabed may be greater than 200 m, typically greater than 500 m.

The method may further include the step of transferring the liquefied or compressed natural gas to a container for temporary storage. The liquefied or compressed natural gas may be stored in the container for from 1 to 60 months, typically from 1 to 6 months.

The container for temporary storage of the liquefied or compressed natural gas may be on the vessel adapted to liquefy the first tranche of the natural gas or vessel adapted to compress the second tranche of the natural gas respectively or may be on a storage vessel specially adapted for the storage of natural gas. The storage vessel may be referred to as a shuttle ship. Appropriate types of storage vessel may collect the liquefied or compressed natural gas from the vessel adapted to liquefy or compress the natural gas respectively and may collect the liquefied or compressed natural gas whilst the natural gas is being produced from the well. This may be referred to as tandem or “side-by-side” off-loading depending on the specific marine environmental conditions, sizes of the associated vessels and operational requirements.

The method may include the step of transporting the liquefied natural gas to a re-gasification plant. The liquefied natural gas may be re-gasified to produce re-gasified natural gas. The method may include the step of transporting the compressed natural gas to a gas terminal where it may be depressurised and fed into a natural gas distribution network.

A connection between the flexible jumper to the vessel adapted to liquefy the first tranche of the natural gas or vessel adapted to compress the second tranche of the natural gas may be via a submerged buoy. The particular type of buoy depends on the metocean (meteorological and oceanographic) conditions that the vessels may be exposed to.

The vessel adapted to liquefy the first tranche of the natural gas may have a production capacity of from 0.9 to 1.2 million tons per annum (mtpa) at a rate of 150 million standard cubic feet per day of feed gas.

The present invention may be particularly suited to the exploitation and therefore removal of natural gas from relatively small reservoirs. Small reservoirs are typically those that contain from 0.5 to 2 trillion (10¹²) cubic feet (tcf) of Gas Initially In Place (GIIP). The present invention may also be particularly suited to the exploitation and therefore removal of natural gas from relatively remote reservoirs. Remote reservoirs are typically those at an extended distance from land or existing infrastructure that could be used to help support the production and transport of natural gas. A remote reservoir is typically from 50 to 500 miles, normally from 70 to 150 miles from land or existing infrastructure.

The method of the present invention may be used to produce natural gas from the at least one reservoir each having a Gas Initially In Place (GIIP) value of equal to or greater than 500 billion (10⁹) cubic feet (bcf), typically equal to or greater than 1000 bcf, and maybe equal to or greater than 2000 bcf.

The present invention may be particularly suited to the exploitation and therefore removal of natural from multiple small and/or remote reservoirs. Remote reservoirs may also be referred to as isolated reservoirs. An isolated reservoir may be one that is at least 50 miles, often more, from existing infrastructure, including platforms and pipelines. An isolated reservoir may be referred to as a stranded reservoir.

The term natural gas is used herein to describe a naturally occurring mixture of hydrocarbon gases. The mixture normally comprises methane and one or more of ethane, propane, butane, and pentane. The mixture may also contain carbon dioxide, nitrogen and hydrogen sulphide.

The subsea architecture for the fields typically comprises one or more subsea wells permitting production from the reservoir. The subsea wells may be connected to a subsea manifold to co-mingle the production from the subsea wells. The subsea manifold may be connected to the free standing riser delivering the production to the near sea surface. The flexible jumper may provide the connection between the free standing riser and the floating vessels.

### BRIEF DESCRIPTION OF THE DRAWING

An embodiment of the invention will now be described by way of example only and with reference to the accompanying drawings, in which:

FIG. 1 is cross section of a reservoir, riser and vessel; and

FIG. 2 is plan view of four neighbouring reservoirs.

### DETAILED DESCRIPTION

FIG. 1 shows the seabed 10, a wellhead 12 and a first riser 14. The first riser 14 connects the wellhead 12 and a floater 16. A flexible jumper 18 connects the floater 16 to a vessel 20, 21 on the sea surface 22 via a turret mooring 24.

In use, natural gas (not shown) flows through the wellhead 12 from the well 26 and gas reservoir 28 to the floater 16. The flexible jumper 18 provides a flow path for the natural gas between the floater 16 and the vessel 20, 21. The floater 16 may be an underwater terminal. The vessel 20 is adapted to liquefying a first tranche of the natural gas (not shown) in the reservoir 28 to produce a liquefied natural gas. The vessel 21 is adapted to compress a second tranche of the natural gas (not shown) in the reservoir 28 to produce a compressed natural gas.

FIG. 2 shows an area 40 comprising four neighbouring offshore, subsea gas reservoirs A, B, C and D. The area 40 covers 200 square miles. The vessel 20 is adapted to liquefy a first tranche of the natural gas from each of the reservoirs A, B, C and D. The vessel 20 may be referred to as a Mobile Liquefied Natural Gas vessel or MLNG vessel.

The vessel 20 is first moved to the waters above reservoir A and then connected to reservoir A such that natural gas (not shown) in reservoir A can be supplied to the vessel 20. The vessel 20 and reservoir A are in fluid communication.

The vessel 20 is used to liquefy a first tranche of the natural gas from reservoir A and remains at reservoir A for 5 years. After this time, the vessel 20 is disconnected from reservoir A and the vessel 20 is moved to the waters above reservoir B. The vessel 20 is then connected to reservoir B such that natural gas (not shown) in reservoir B can be supplied to the vessel 20.

The vessel 20 is used to liquefy a first tranche of the natural gas from reservoir B and remains at reservoir B for 5 years. After this time the vessel 20 is disconnected from reservoir B and the vessel 20 is moved to the waters above reservoir C.

The sequence of events is then repeated for reservoir C and then reservoir D. After the vessel 20 has liquefied a first tranche of the natural gas from each of the reservoirs A, B, C and D, the vessel 20 may be taken to other suitable gas reservoirs (not shown).

After the vessel 20 is disconnected from reservoir A and moved to the waters above reservoir B, a second vessel 21 is connected to the reservoir A. The vessel 21 and reservoir A are connected such that natural gas (not shown) in reservoir A can be supplied to the vessel 21. The vessel 21 and reservoir A are then in fluid communication. The second vessel 21 is adapted to compress a second tranche of the natural gas in reservoir B and remains at reservoir B for 10 years. After this time the vessel 21 is disconnected from reservoir A and the vessel 21 is moved to the waters above reservoir B or C. The vessel 21 is then connected to reservoir B or C such that natural gas (not shown) in reservoir B or C can be supplied to the vessel 21.

The sequence of events is then repeated for the other reservoirs C or B and then reservoir D. After the vessel 21 has compressed a second tranche of the natural gas from each of the reservoirs A, B, C and D, the vessel 21 may be taken to other suitable gas reservoirs (not shown).

Further details of the process of producing natural gas from the reservoir 28 will now be described.

Liquefied natural gas (LNG) is natural gas that has been cooled and condensed to a liquid. This makes storage and transport of the gas relatively easy. LNG occupies approximately 1/600^{th} the volume of natural gas at atmospheric pressure. The liquefaction process involves the removal of contaminants and then condensing the natural gas to a liquid at atmospheric pressure by cooling it, typically at from −120 to −170° C. (−184 to −274° F.). The temperature required to liquefy natural gas depends on its composition.

Compressed natural gas (CNG) is natural gas that has been compressed. CNG is made by compressing natural gas to less than 1% of its volume at atmospheric pressure. It may be compressed further so that is occupies approximately 1/300^{th} the volume of natural gas at atmospheric pressure.

The same amount or mass of natural gas when stored as CNG therefore occupies a greater volume than the same amount or mass of natural gas when stored as LNG. The cost of compressing and storing natural gas as CNG is typically less than the cost of liquefying and storing natural gas as LNG. In particular, LNG requires the natural gas to be stored as a super-cooled, or cryogenic, liquid. Once compressed and cooled the LNG has an energy density comparable to petrol and diesel.

The cost of transporting the natural gas is higher for CNG compared to LNG. This is because of the volume of natural gas per unit mass when stored as CNG is approximately twice that of the volume of natural gas per unit mass when stored as LNG. A transportation vessel used to transport the LNG from the LNG installation or CNG from the CNG installation to land or other transportation infrastructure such as a pipeline, can therefore hold approximately twice the amount or mass of LNG compared to CNG and therefore need only make approximately half the number of journeys. This significantly reduces transportation costs and potential downtime whilst the transportation vessel is away from the LNG installation. The re-gasification of CNG is however less complex and therefore less expensive than that of LNG.

The overall higher cost of LNG means that to be economically viable and therefore offset the cost of the LNG installation, the gas reservoir must have enough natural gas to sustain approximately 5 years of production at a suitable flow rate. This means that LNG and particularly offshore Floating LNG (FLNG) installations are usually not suitable for smaller and/or more marginal or isolated reservoirs that have smaller reserves and cannot sustain sufficient flow rate for a sufficient period of time. Therefore they do not support the capital expenditure for the LNG installation and associated infrastructure.

The cost of installing and using a CNG installation to collect, compress and prepare produced gas for transport, particularly offshore, is typically lower than that of a comparable LNG installation, however the rate of return from a CNG installation is also typically lower than that of a LNG installation. The daily cost of running CNG and LNG installations may be the same or similar but the revenue per day generated by a LNG installation is typically greater than that of a comparable CNG installation.

The cost of designing and building a Floating Liquefied Natural Gas (FLNG) vessel is typically in the order of £1 billion. The cost of designing and building a Floating Compressed Natural Gas (FCNG) vessel is typically in the order of £150 million.

The rate of return from a CNG installation may less or slower than that from a comparable LNG installation. It may be difficult to get the necessary rate return on the investment needed to plan and build the CNG installation and connect it to a hydrocarbon reservoir. This is especially a problem for FCNG installations where the upfront costs may be greatest. It may be easier to get the necessary rate return on the investment needed to plan and build a LNG installation and connect it to a hydrocarbon reservoir.

The rate of production of natural gas through a well from a natural gas reservoir is typically not constant over the lifetime of the well. The flow rate of natural gas through the well is typically slow at the beginning, then usually increases before reaching a maximum flow rate and then beginning to slow until it becomes uneconomical to keep the well open.

Collecting and storing natural gas using a LNG installation is therefore well suited to the typical initial flow profile of natural gas from a well. Whilst the initial costs of planning and building the LNG installation are high compared to other available technologies, the flow rate of natural gas produced and therefore rate of revenue generated from the well is higher at the start of production compared to towards the end of the lifetime of the well.

This is however typically not the case when exploiting small and/or remote natural gas reservoirs. Small natural gas reservoirs are typically those having a Gas Initially In Place (GIIP) value of equal to or less than 500 billion (10⁹) cubic feet (bcf). The problem is that neither the initial rate of production from the smaller reservoirs or the total volume of natural gas produced may be sufficient for a LNG installation, particularly a FLNG installation, to be economically viable over the lifetime of the reservoir.

Alternative methods of processing and storing the natural gas such as CNG or FCNG may be better suited to the total revenue expected from the reservoir because they are less expensive to operate but the initial rate of return from the reservoir may be too low to make it economically viable, especially because of the upfront costs involved in installing and securing a well connection from the reservoir to the surface and then to a means of collecting the natural gas. These initial costs are even greater for remote reservoirs because of the increased cost of transportation and other logistical hurdles.

If the natural gas that is first produced from the gas reservoir is converted to LNG and then the remaining natural gas is converted to CNG, the upfront cost of installing the well and making a connection between the surface and the reservoir can be paid for using the greater revenue generated when the natural gas is being converted to LNG. The revenue generated by the natural gas converted to CNG does not therefore subsequently need to pay for installing the well and making the connection between the surface and the reservoir.

Current regulations mean that operators removing hydrocarbons, including natural gas, from a reservoir should not abandon the production of hydrocarbons from that reservoir until most of the available hydrocarbons, including natural gas, have been removed. The present invention may provide a way of meeting these regulations.

The method described herein may be suitable for use with natural gas reservoirs located off the African coast. African gas reservoirs may be difficult to commercialise due one or more of a low local gas consumption history; a significant export distances to bigger gas markets and the associated costs; a lack of nearby gas handling infrastructure and facilities; and a weak offshore service industry.

Modifications and improvements can be incorporated without departing from the scope of the invention.

1. A method of producing natural gas from at least one reservoir, the method including the steps of:
producing the natural gas from the at least one reservoir;
liquefying a first tranche of the natural gas to produce liquefied natural gas; and
compressing a second tranche of the natural gas to produce a compressed natural gas.

2. The method of producing natural gas according to claim 1, wherein the step of liquefying the first tranche of the natural gas to produce liquefied natural gas is done using a dedicated marine floating vessel adapted to liquefied natural gas.

3. The method of producing natural gas according to claim 1, wherein the step of compressing the second tranche of the natural gas to produce a compressed natural gas is done using a dedicated marine floating vessel adapted to compress natural gas.

4. The method of producing natural gas according to claim 1, wherein the step of compressing the second tranche of the natural gas to produce the compressed natural gas is after the step of liquefying the first tranche of the natural gas to produce the liquefied natural gas.

5. The method of producing natural gas according to claim 1, wherein the step of liquefying the first tranche of the natural gas to produce the liquefied natural gas lasts from 3 to 8 years.

6. The method of producing natural gas according to claim 2, wherein the method includes the step of connecting a flexible jumper to the dedicated marine floating vessel adapted to liquefy the first tranche of the natural gas.

7. The method of producing natural gas according to claim 3, wherein the method includes the step of disconnecting a flexible jumper from a vessel adapted to liquefy the first tranche of the natural gas and connecting it to the vessel adapted to compress the second tranche of the natural gas.

8. The method of producing natural gas according to claim 1, wherein after disconnecting a flexible jumper from the vessel adapted to liquefy the first tranche of the natural gas, the method further includes the step of disconnecting the flexible jumper from a floater and changing the flexible jumper for one that is suitable for connection to a vessel adapted to compress the second tranche of the natural gas.

9. The method of producing natural gas according to claim 8, wherein when there is more than one reservoir and once the flexible jumper has been disconnected from the vessel adapted to liquefy the first tranche of the natural gas, the same vessel is moved to a second reservoir and used in the production of natural gas from this second reservoir.

10. The method of producing natural gas according to claim 1, wherein the reservoir is a gas reservoir.

11. The method of producing natural gas according to claim 1, wherein when there is more than one reservoir, the reservoirs are from 5 to 100 miles apart.

12. The method of producing natural gas according to claim 1, wherein the reservoir is offshore and under the seabed.

13. The method of producing natural gas according to claim 1, wherein the method further includes the step of transferring the liquefied or compressed natural gas to a container for temporary storage.

14. The method of producing natural gas according to claim 13, wherein the liquefied or compressed natural gas is stored in the container for from 1 to 60 months.

15. The method of producing natural gas according to claim 13, wherein the container for temporary storage of the liquefied or compressed natural gas is on a storage vessel specially adapted for the storage of natural gas.

16. The method of producing natural gas according to claim 1, wherein the method includes the step of transporting the liquefied natural gas to a re-gasification plant.

17. The method of producing natural gas according to claim 1, wherein the method includes the step of transporting the compressed natural gas to a gas terminal.

18. The method of producing natural gas according to claim 2, wherein the vessel adapted to liquefy the first tranche of the natural gas has a production capacity of from 0.9 to 1.2 million tons per annum at a rate of 150 million standard cubic feet per day of feed gas.

19. The method of producing natural gas according to claim 1, wherein the natural gas is removed from small reservoirs containing from 0.5 to 2 trillion cubic feet of Gas Initially In Place.

20. The method of producing natural gas according to claim 1, wherein the natural gas is removed from remote reservoirs being from 50 to 500 miles from existing infrastructure.
